(19) United States
(12) Patent Application Publication
(10) Pub. No.: US 2026/0225921 A1
(43) Pub. Date: Aug. 6, 2026

(54) ENERGY-FREE AND SPONTANEOUS REVERSE OSMOSIS DEVICE

(71) Applicant: Xi'an Xishizun Electromechanical Technology Co., Ltd., Xi'an (CN)

(72) Inventors: Demin Huang, Xi'an (CN); Qi Huang, Xi'an (CN)

(21) Appl. No.: 19/081,383

(22) Filed: Mar. 17, 2025

(30) Foreign Application Priority Data
Feb. 6, 2025 (CN) 2025101324237

(51) Int. Cl. C02F 1/44; B01D 61/00; B01D 61/02; B01D 61/08; B01D 61/58; C02F 103/00; C02F 103/08

(52) U.S. Cl. CPC C02F 1/441; B01D 61/0022; B01D 61/005; B01D 61/025; B01D 61/08; B01D 61/58; C02F 1/445; B01D 2311/14; B01D 2313/90; B01D 2319/02; C02F 2103/005; C02F 2103/08; C02F 2209/03

(57) ABSTRACT

An energy-free and spontaneous reverse osmosis device includes first and second semipermeable membranes. A pore distribution density of the first semipermeable membrane is lower than that of the second semipermeable membrane, and a first aqueous solution is filled between a middle side of the first semipermeable membrane and a middle side of the second semipermeable membrane, another side of the first semipermeable membrane is filled with pure water, and another side of the second semipermeable membrane is filled with a second aqueous solution. A second pressure exerted on the first semipermeable membrane by the first aqueous solution is greater than an osmotic pressure of the first semipermeable membrane, thereby creating reverse osmosis to cause water from the first aqueous solution to flow through the first semipermeable membrane into the pure water. The device achieves spontaneous reverse osmosis and directly use environmental thermal energy.

### TECHNICAL FIELD

The disclosure relates to the field of reverse osmosis technologies, and particularly to an energy-free and spontaneous reverse osmosis device.

### BACKGROUND

Osmosis and reverse osmosis have been widely applied in fields such as biology, wastewater purification, and seawater desalination. The osmosis refers to a spontaneous flow of solvent from a low-concentration solution to a high-concentration solution, while the reverse osmosis involves applying pressure to force solvent permeation from the solution. It is widely accepted that the reverse osmosis cannot occur spontaneously and requires energy input to be realized. As energy serves as the foundation for human survival and development, the associated energy consumption exacerbates global temperature rise, which is an increasingly critical challenge for human. Currently, environmental thermal energy existing in air, water, and soil is considered waste heat. The widely distributed environmental thermal energy contains enormous potential. If harnessed effectively, the environmental thermal energy could be transformed into valuable resources. Direct utilization of the environmental thermal energy for work could potentially address both humanity's energy demands and the root cause of temperature rise caused by conventional energy consumption. However, existing publicly available technologies remain incapable of directly harnessing environmental thermal energy.

### SUMMARY

To address the above technical challenges, the disclosure provides an energy-free and spontaneous reverse osmosis device (also referred to as non-energy-consuming spontaneous reverse osmosis device). By directly utilizing environmental thermal energy to perform work, the disclosure transforms waste into valuable resources. It not only holds promise for resolving humanity's energy supply issues but also potentially eliminates the root cause of global temperature rise exacerbated by energy consumption, while simultaneously reducing carbon emissions.

The specific technical solutions of the disclosure are as follows.

An energy-free and spontaneous reverse osmosis device includes a first semipermeable membrane and a second semipermeable membrane. A pore distribution density of the first semipermeable membrane is lower than that of the second semipermeable membrane, and a first aqueous solution is filled between a middle side of the first semipermeable membrane and a middle side of the second semipermeable membrane, another side of the first semipermeable membrane is filled with pure water, and another side of the second semipermeable membrane is filled with a second aqueous solution. A first pressure exerted on the second semipermeable membrane by the first aqueous solution is less than an osmotic pressure of the second semipermeable membrane, thereby creating an osmotic effect to cause water from the second aqueous solution to flow through the second semipermeable membrane into the first aqueous solution. A second pressure exerted on the first semipermeable membrane by the first aqueous solution is greater than an osmotic pressure of the first semipermeable membrane, thereby creating reverse osmosis to cause water from the first aqueous solution to flow through the first semipermeable membrane into the pure water.

In an embodiment, a particle size of a solute in the first aqueous solution is larger than a pore size of the first semipermeable membrane and a pore size of the second semipermeable membrane.

In an embodiment, a relationship between the first semipermeable membrane and the osmotic pressure or a relationship between the second semipermeable membrane and the osmotic pressure is expressed as follows:

$$π = KcRT$$

where π represents the osmotic pressure, c represents a concentration difference between two sides of the first semipermeable membrane or two sides of the second semipermeable membrane, K represents a permeability coefficient of the first semipermeable membrane or the second semipermeable membrane, R represents a universal gas constant, and T represents a thermodynamic temperature. It should be noted that the formula is a newly derived osmotic pressure equation based on microscopic mechanism of osmosis. It maintains compatibility with a conventional osmotic pressure formula π=CRT while introducing novel predictions. Specifically, the permeability coefficient of semipermeable membrane (i.e., osmotic coefficient) K increases with higher pore distribution density of the semipermeable membrane, resulting in greater corresponding osmotic pressure π. Conversely, lower pore distribution density of the semipermeable membrane reduces the permeability coefficient K, leading to diminished osmotic pressure π.

In an embodiment, the second aqueous solution is pure water, seawater or sewage.

In an embodiment, when the second aqueous solution is the pure water, the device is configured to lift the pure water from a lower position to a higher position, or to perform water supply, or to perform power generation.

In an embodiment, when the device is configured to lift the pure water from the lower position to the higher position sequentially from the second aqueous solution, the second semipermeable membrane, the first aqueous solution, the first semipermeable membrane, and the pure water. The water in the second aqueous solution flows from the lower position through the second semipermeable membrane into the first aqueous solution, and the water in the aqueous solution flows through the first semipermeable membrane into the pure water at the higher position.

In an embodiment, when the device is configured to perform the water supply, the pure water is delivered to the user end.

In an embodiment, when the device is configured to perform the power generation, the pure water is drained or allowed to flow into the second aqueous solution, thereby creating a water flow. A generator is disposed in a path of the water flow to generate electricity using the water flow.

In an embodiment, when the second aqueous solution is the seawater or the sewage, the device is configured to perform seawater desalination or sewage purification.

Compared to the related art, the beneficial effects of the disclosure are as follows.

The disclosure provides an energy-free and spontaneous reverse osmosis device, which includes a first semipermeable membrane and a second semipermeable membrane. The pore distribution density of the first semipermeable membrane is lower than that of the second semipermeable membrane. A first aqueous solution is filled between a side of the first semipermeable membrane and a side of the second semipermeable membrane. Another side of the first semipermeable membrane is filled with pure water, and another side of the second semipermeable membrane is filled with a second aqueous solution. A first pressure exerted on the second semipermeable membrane by the first aqueous solution is less than an osmotic pressure of the second semipermeable membrane, thereby creating an osmotic effect to cause water from the second aqueous solution to flow through the second semipermeable membrane into the first aqueous solution. A second pressure exerted on the first semipermeable membrane by the first aqueous solution is greater than an osmotic pressure of the first semipermeable membrane, thereby creating reverse osmosis to cause water from the first aqueous solution to flow through the first semipermeable membrane into the pure water. Through the above process, the water can continuously flow from the side of the second semipermeable membrane to another side of the first semipermeable membrane. This process relies on molecular thermal motion, which is essentially the spontaneous transformation of the chaotic thermal motion of water molecules into macroscopic water flow through the nanoscale one-way valve effect, without the need for external electrical energy to achieve spontaneous reverse osmosis. The disclosure directly utilizes ambient thermal energy to perform work, turning waste into treasure. It has the potential to address the issue of human energy sources and eliminate the root cause of increased global warming due to energy consumption, thereby reducing carbon emissions.

### BRIEF DESCRIPTION OF DRAWINGS

FIG. 1 illustrates a schematic diagram of a microscopic working mechanism of osmotic effect nanoscale one-way valve (also referred to as nano osmotic check valve).

FIG. 2 illustrates a schematic diagram of an energy-free and spontaneous reverse osmosis device based on a membrane pore differential method.

FIG. 3 illustrates a schematic diagram of a spontaneous reverse osmosis circulation system.

FIG. 4 illustrates a schematic diagram of power generation using the spontaneous reverse osmosis circulation system.

FIG. 5 illustrates a schematic diagram of the energy-free and spontaneous reverse osmosis device for lifting water without power.

### DETAILED DESCRIPTION OF EMBODIMENTS

In order to enable those skilled in the art to better understand the technical solution of the disclosure and its implement ability, the disclosure will be further described below in conjunction with specific embodiments and drawings. However, the embodiments are not intended to limit the scope of the disclosure. In the following embodiments, unless otherwise specified, the experimental methods and detection methods mentioned are conventional methods, and the reagents and materials mentioned, unless otherwise specified, are commercially available.

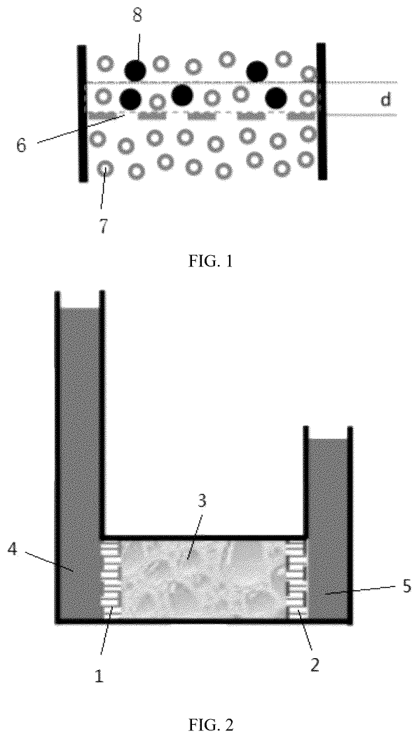

As shown in FIG. 2, an energy-free and spontaneous reverse osmosis device includes a first semipermeable membrane 1 and a second semipermeable membrane 2. A pore distribution density of the first semipermeable membrane 1 is lower than that of the second semipermeable membrane 2, and a first aqueous solution 3 is filled between a side of the first semipermeable membrane 1 and a side of the second semipermeable membrane 2. Another side of the first semipermeable membrane 1 is filled with pure water 4, and another side of the second semipermeable membrane 2 is filled with a second aqueous solution 5. A first pressure exerted on the second semipermeable membrane 2 by the first aqueous solution 3 is less than an osmotic pressure of the second semipermeable membrane 2, thereby creating an osmotic effect to cause water from the second aqueous solution 5 to flow through the second semipermeable membrane 2 into the first aqueous solution 3. A second pressure exerted on the first semipermeable membrane 1 by the first aqueous solution 3 is greater than an osmotic pressure of the first semipermeable membrane 1, thereby creating reverse osmosis to cause water from the first aqueous solution 3 to flow through the first semipermeable membrane 1 into the pure water 4. A particle size of a solute in the first aqueous solution 3 is larger than a pore size of the first semipermeable membrane 1 and a pore size of the second semipermeable membrane 2. The second aqueous solution 5 is pure water, seawater or sewage.

It should be noted that in practical applications, it is possible to customize semipermeable membranes with specific pore distribution densities individually. Alternatively, the pore distribution density of the semipermeable membrane can be adjusted by stacking multiple semipermeable membranes. For example, multiple second semipermeable membranes 2 can be stacked to create the first semipermeable membrane 1. Due to mutual blocking, the overall pore distribution density of the stacked second semipermeable membranes 2 is reduced. Depending on the actual requirements, the number and stacking method of the second semipermeable membranes 2 can be adjusted.

To verify the feasibility of the above device, the disclosure conducts the following experiments: The second aqueous solution 5 is set as pure water, and the first semipermeable membrane 1 is formed by stacking two second semipermeable membranes 2. A water level difference experiment and a water-lifting experiment are carried out respectively.

The water level difference experiment: an experimental principle is shown in FIG. 2. Initially, water levels of the pure water 4 and the second aqueous solution 5 are equal. After one hour, it is observed that the water level of the pure water 4 is approximately 330 millimeters (mm) higher than that of the second aqueous solution 5. The experiment confirmed that when a pre-set water level difference of 12.6 m is applied, the higher water level could still rise further.

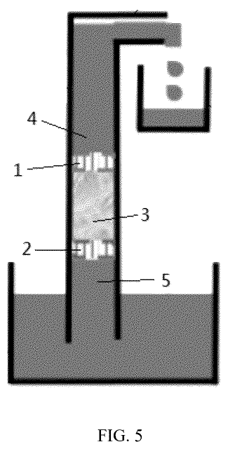

The water-lifting experiment: an experimental principle is shown in FIG. 5. The water is lifted to a height of approximately 28 mm, with water droplets falling approximately every 6 seconds. The experiment demonstrated that the technical principle is feasible and the method is effective.

In the above content, the pore distribution density of the first semipermeable membrane 1 is lower than that of the second semipermeable membrane 2. This results in a lower osmotic pressure on the side corresponding to the first semipermeable membrane 1 and a higher osmotic pressure on the side corresponding to the second semipermeable membrane 2. The theoretical basis for this is explained as follows.

A relationship between the semipermeable membrane and the osmotic pressure is expressed as follows:

$$π = KcRT$$

where π represents the osmotic pressure, c represents a concentration difference between two sides of the semipermeable membrane, K represents a permeability coefficient of the semipermeable membrane, R represents a universal gas constant, and T represents a thermodynamic temperature. It should be noted that, compared with the traditional van't Hoff formula for osmotic pressure π=cRT, the formula mentioned above includes an additional permeability coefficient K, which reflects that the osmotic pressure is related to the pore distribution density of the membrane. When membrane pores are sufficiently dense, K=1, and the above formula reverts back to the van't Hoff formula, being identical to it. This indicates that the van't Hoff formula is merely an idealized special case of this osmotic pressure formula. The new formula provided by the disclosure is compatible with the van't Hoff formula.

A derivation process of the osmotic pressure formula of the disclosure is specifically as follows: the osmotic effect is a phenomenon caused by the solute particles in an aqueous solution covering the pores of a semipermeable membrane, which results in an asymmetry in the bidirectional diffusion of water molecules across the membrane. More water molecules move from the side with lower concentration through the semipermeable membrane to the side with higher concentration. This effect is driven by the kinetic energy from the thermal motion of the molecules themselves and is entirely spontaneous. The microscopic working mechanism of the osmotic effect as a nanoscale one-way valve is shown in FIG. 1.

As shown in FIG. 1, black vertical lines represent walls of a container, a black horizontal thick dashed line represents the semipermeable membrane, black small hollow spheres represent water molecules, and the black small spheres represent solute particles. Black thin dashed lines are all reference lines. According to the principle of the nanoscale one-way valve, the black solute particles and the membrane pores together form a nanoscale one-way valve, which blocks the diffusion of water molecules from the top to the bottom but allows the diffusion of water molecules from the bottom to the top. Not all solute particles can form a nanoscale one-way valve with the membrane pores, only those solute particles at the membrane interface can do so. If a solute particle is too far from the membrane, and there are water molecules between the particle and the membrane, the particle cannot block these water molecules from diffusing through the semipermeable membrane pores, and thus it cannot form a nanoscale one-way valve with the membrane pores. A near-range area at the membrane interface, where solute particles can form a nanoscale one-way valve with the membrane pores, is referred as an “effective region of the nanoscale one-way valve action interface.” This region is marked with the black thin dashed lines in square in FIG. 1. The three black particles within the square can form a nanoscale one-way valve with the membrane pores below, while the two black particles above the square cannot block the water molecules from passing through the membrane pores due to the presence of water molecules between them and the membrane. The two particles are outside the action interface and cannot form a nanoscale one-way valve with the membrane pores. In FIG. 1, a thickness of the action interface is indicated by the black thin dashed lines and is denoted as d. If the distance between a particle and the membrane is greater than the diameter of a water molecule, there will be water molecules between them, and the particle cannot block these water molecules from passing through the semipermeable membrane pores. Therefore, the thickness of the osmotic action interface is approximately the sum of the diameter of the solute particle and the diameter of the water molecule.

As shown in FIG. 1, a density of the solution is set as p, a number of solute particles per unit volume of the solution is set as n, and a semipermeable membrane is placed between the solution and pure water. An area of the semipermeable membrane is S, and the thickness of the effective region of the nanoscale one-way valve action interface is d. Therefore, the volume of the effective region of the nanoscale one-way valve action interface is dS, a mass of the solution within this region is m=ρdS, and a corresponding total number of solute particles is ndS. As shown in FIGS. 1-5, 1, 6 represents the pores in the semipermeable membrane, 7 represents the water molecules, and 8 represents the solute particles.

If the pores in the semipermeable membrane are sufficiently dense, with the distance between pores being less than the diameter of the solute particles, these solute particles will always block at least one membrane pore, thereby forming a nanoscale one-way valve. Therefore, under ideal conditions, the total number of nanoscale one-way valves is dndS. Considering that the actual spacing between membrane pores may be relatively large, the solute particles within the action interface may not necessarily have corresponding pores to form nanoscale one-way valves. The pore distribution density of the membrane directly affects the pairing of particles with pores. When the spacing between membrane pores is less than the particle diameter, the particles can block at least one pore. However, when the spacing between membrane pores is greater than the particle diameter, the particles may not be able to cover any pores. A probability of particles pairing with membrane pores is defined as the “permeability coefficient K”. Clearly, the permeability coefficient K is related to the size of the particles and pores, as well as the pore distribution density of the membrane. When the membrane pores are sufficiently dense and the spacing between pores is less than the particle diameter, the probability of solute particles within the action interface covering the pores is 100%, and thus K=1. If the membrane is completely pore-free, then K=0. Typically, the probability of solute particles within the action interface covering the pores is greater than 0 and less than 1, i.e., 0≤K≤1. In this case, within the effective region of the nanoscale one-way valve action interface, the number of nanoscale one-way valves that can be formed by the pairing of particles and pores is KndS.

An average time interval for a water molecule to pass through a membrane pore is referred to as an “osmotic cycle”. The permeation and results of the entire semipermeable membrane during the osmotic cycle are termed as “one osmosis”. Each nanoscale one-way valve corresponds to one water molecule. During the one osmosis, KndS nanoscale one-way valves will cause KndS more water molecules to enter the upper solution from below than to enter the water from above.

A physical quantity that characterizes the intensity of molecular thermal motion is the average kinetic energy of molecules, and macroscopic temperature is a measure of the average kinetic energy of molecules. For ideal gas molecules, the relationship between the average translational kinetic energy of molecules and temperature is expressed as follows:

$${E}_{K} = \frac{3}{2} \frac{R}{{N}_{A}} T \qquad ( 1 )$$

where R represents a universal gas constant, and R=8.31 J/k.mol; N_{A} represents Avogadro's number, T represents thermodynamic temperature, measured in kelvins (K). The equation (1) is also considered applicable to the relationship between the average kinetic energy of molecules in a solution and temperature.

According to equation (1), a sum of the kinetic energies of KndS water molecules is expressed in equation (2) as follows:

$${E}_{K} = \frac{3}{2} \frac{R}{{N}_{A}} KndST \qquad ( 2 )$$

In FIG. 1, KndS water molecules pass through the semipermeable membrane to the upper side, bringing a total kinetic energy of

$$E = \frac{3}{2} \frac{R}{{N}_{A}} KndST$$

to the solution in that region. After several collisions with the particles, these water molecules fully exchange energy, and the kinetic energy is dispersed and transferred to all particles in all directions. Considering that molecular motion has no preferential direction in three-dimensional space, and ideally, the kinetic energy is equally distributed among the three dimensions, each dimension will receive one-third of the total kinetic energy mentioned above, which is expressed in equation (3) as follows:

$${E}_{1} = \frac{1}{2} \frac{R}{{N}_{A}} KndST$$

After osmosis, if the flow of the solution is not restricted, the kinetic energy acquired by the water molecules will promote the movement of the liquid in the corresponding direction. In FIG. 1, the container restricts the horizontal movement of the liquid, while the vertical movement is not restricted. Therefore, the kinetic energy in the vertical direction will promote the vertical movement of the liquid. Considering that the liquid is in a gravitational field, this movement causes the solution level to rise and increases its potential energy.

An osmosis cycle (i.e., the one osmosis) cannot raise the liquid level to the maximum height corresponding to the vertical kinetic energy all at once. This is because the effective region of the nanoscale one-way valve action interface is very thin, and the corresponding volume of water is very small, usually much less than the total volume of liquid in the container. The additional kinetic energy brought to the liquid by the KndS water molecules passing through the semipermeable membrane can only cause a very small rise in the entire liquid level. In particular, the surface tension of the liquid is very strong. Before osmotic equilibrium is reached, even if the water molecules that have permeated through have a significant upward kinetic energy, it is difficult for them to break through the surface tension and rise alone. Instead, they can only rise together with the entire liquid surface, with the remaining kinetic energy still residing within the liquid.

As the osmosis continues, the liquid level in the container gradually rises, and the potential energy of the liquid continuously increases. This potential energy is converted into kinetic energy, which drives water molecules to flow downward through the pores of the semipermeable membrane more quickly. Macroscopically, this manifests as an increase in pressure at the bottom of the container, with more water flowing through the semipermeable membrane per unit of time. As the liquid level rises higher and higher, the effect of potential energy becomes stronger. The incoming water molecules need to contribute more vertical kinetic energy to overcome the potential energy and do work. Eventually, the kinetic energy and quantity of water molecules flowing out due to the increased potential energy reach equilibrium with the kinetic energy and quantity of water molecules flowing in through osmosis, and the liquid level no longer rises. At this point, the hydrostatic pressure of the liquid level relative to the position of the semipermeable membrane is the osmotic pressure.

If the formula for osmotic pressure is derived by considering the entire process, including the shape and volume of the container, changes in inflow and outflow rates, variations in solution concentration, and the duration of the process, it becomes extremely complex and difficult to calculate. However, it is well-known that the larger the volume of the solution, the smaller the liquid level rise caused by the one osmosis. Conversely, the smaller the volume of the solution, the greater the liquid level rise caused by the one osmosis. By reasoning step-by-step, if the volume of the solution is reduced to the smallest effective unit, the liquid level rise caused by the one osmosis represents the maximum or ultimate capacity for liquid level rise of that particular permeation.

Referring to FIG. 1, the effective region of the nanoscale one-way valve action interface marked by the black thin dashed line in square is such a minimal effective unit (referring to the thinnest possible solution thickness, with the area being arbitrary). Any smaller, and it would no longer constitute a complete, comprehensive, and accurate formation and functioning of the nanoscale one-way valve. Thus, the maximum height that this minimal effective unit can rise to represents the ultimate height that the osmosis can achieve.

Assuming that in FIG. 1, there is no longer any solution above, and only the liquid within the minimal effective unit marked by the black thin dashed lines remains, and disregarding the interactions between the liquid and the container at the solid-liquid interface, how high this minimal effective unit can rise in an ideal scenario due to the one osmosis is examined. Now, how much the center of mass of the aqueous solution in this region will be raised if all the kinetic energy in the vertical direction is converted entirely into potential energy of the liquid is calculated.

For dilute aqueous solutions, the number of nanoscale one-way valves that can be formed is relatively low, and consequently, the number of water molecules entering the effective region of the action interface from below is also limited. For the sake of simplification in the calculations, their mass and volume will be disregarded. Given that the minimal effective unit is extremely thin, and the initial gravitational potential energy of the liquid within this unit is also neglected.

A relationship between kinetic energy and potential energy is given by mgh=E, where m represents a mass of the object, g represents gravitational acceleration, and h represents a height of the object. Specifically, for the liquid in the specification, the mass m is ρdS. m and the value of E₁ from the equation (3) are substituted into the kinetic and potential energy conversion formula expressed as follows:

$$ρ dSgh = \frac{1}{2} \frac{R}{{N}_{A}} KndST \qquad ( 4 )$$

By canceling dS from both sides:

$$ρ gh = \frac{1}{2} \frac{R}{{N}_{A}} KnT \qquad ( 5 )$$

The equation (5) reflects the maximum height that a center of mass of the liquid in the minimal effective unit can reach during the one osmosis. However, the liquid level height is need to be concerned with, which can be derived from the center of mass height. For a liquid column with a uniform cross-section, the center of mass is located at the midpoint of the column. Therefore, the liquid level height is twice the height of the center of mass, the liquid level height is set as H, then

$$h = \frac{1}{2} H ,$$

followed by substituting h into the equation (5), thereby obtaining equation (6) expressed as follows:

$$ρ gH = \frac{R}{{N}_{A}} KnT \qquad ( 6 )$$

The equation (6) represents the maximum height that the liquid level of the minimal effective unit can reach during the one osmosis.

Considering that μgH represents hydrostatic pressure, a traditional notation for osmotic pressure is used, and denoted as π. Meanwhile,

$$\frac{n}{{N}_{A}}$$

represents a molar concentration per unit volume, the traditional notation for osmotic pressure is used, and denoted as c, then the equation (6) can be rewritten as equation (7) expressed as follows:

$$π = KcRT \qquad ( 7 )$$

Furthermore, when both sides of the semipermeable membrane are aqueous solutions, it can be demonstrated that c in the equation represents the concentration difference between the two aqueous solutions.

The equation (7) represents the osmotic pressure formula derived based on the nanoscale one-way valve mechanism. Compared with the van't Hoff formula, it includes an additional permeability coefficient K, which reflects that the osmotic pressure is related to the pore distribution density of the membrane.

When the membrane pores are sufficiently dense, K=1, and the equation (7) reverts back to the van't Hoff formula (8) expressed as follows:

$$π = cRT \qquad ( 8 )$$

The equation (8) is identical to the van't Hoff formula, which indicates that the van't Hoff formula is merely an idealized special case of this osmotic pressure formula. The new formula is compatible with the van't Hoff formula.

The liquid pressure depends on the height of the liquid and is independent of the cross-sectional area of the liquid and the size of the water body. The movement of liquid molecules inside the liquid does not need to consider the interface effect. The maximum height that the minimal effective unit of the one osmosis can reach is also the ultimate height that the entire liquid permeation can achieve. When the container is large and the amount of water is substantial, it takes several permeations for the liquid level to reach the ultimate height.

The equation (7) indicates that the osmotic pressure depends not only on the concentration and temperature of the solution but also on the characteristics of the membrane. When the pore distribution density of the membrane is higher, the osmotic pressure is greater; conversely, when the pore distribution density is lower, the osmotic pressure is lower. For the same solution, if it is separated by two semipermeable membranes with the same pore size but different pore distribution densities, there will be different osmotic pressures.

The interpretation of the osmotic mechanism based on the nanoscale one-way valve model and the derivation of the formula further reveal the microscopic working mechanism of the osmotic effect. This not only explains what traditional osmotic mechanisms can explain but also explains what traditional mechanisms cannot, including but not limited to the following aspects.

A. The energy basis of osmosis is molecular thermal motion. Solvent molecules can pass through a semipermeable membrane due to the diffusive movement from their thermal motion. The rise in the liquid level of an aqueous solution is caused by the partial conversion of the kinetic energy from molecular thermal motion into potential energy of the liquid. The more vigorous the molecular thermal motion, the higher the osmotic pressure formed. If the diffusive motion of molecules is lost, for example, when water freezes, it cannot pass through a semipermeable membrane, and thus no osmotic effect can be formed. The macroscopic manifestation of molecular thermal motion is temperature; the higher the temperature, the greater the osmotic pressure.

B. Osmosis is an interfacial effect. The osmotic effect originates from the covering of semipermeable membrane pores by solute particles. Only the particles near the interfacial layer of the semipermeable membrane can cover the pores and prevent solute particles from passing through the membrane pores due to diffusive motion. Particles that are farther away do not have a blocking effect. Therefore, the concentration of the solution at the semipermeable membrane interface, rather than the entire solution concentration, determines the magnitude of the osmotic pressure.

C. The magnitude of osmotic pressure is related to the characteristics of the membrane. The new osmotic pressure formula indicates that, in addition to being directly proportional to the concentration and temperature of the solution, the magnitude of osmotic pressure is also related to the distribution density of the membrane pores. The sparser the membrane pores, the fewer the number of nanoscale one-way valves that can be formed by the pairing of solute particles and membrane pores, resulting in lower osmotic pressure. In fact, this situation is equivalent to a decrease in the concentration of solute particles, as both result in a reduction in the number of nanoscale one-way valves.

D. The magnitude of osmotic pressure is independent of the hygroscopic nature of the solute, among other factors. In the nanoscale one-way valve model, solute particles only serve to cover the membrane pores, which is clearly unrelated to their hygroscopic or chemical properties, provided that the solute particles do not adhere to the semipermeable membrane.

The van't Hoff formula is an ideal osmotic pressure formula. The new osmotic pressure formula can degenerate into the van't Hoff formula under ideal conditions, which to some extent proves the correctness of the new interpretation and formula derivation. The new interpretation and formula have a broader applicability and stronger predictive power. There are two methods to test the correctness of the new formula. One is the “concentration difference method”, which involves regulating the interfacial concentration at the semipermeable membrane to create a concentration difference that leads to an osmotic pressure difference. The other is the “membrane pore difference method”, which involves using two semipermeable membranes with different pore densities to create an osmotic pressure difference.

When another side of the second semipermeable membrane 2 is filled with pure water, FIG. 2 is used to illustrate the corresponding concept. In FIG. 2, black lines represent walls of the container. Shadow areas on the left and right inside the container represent pure water, and water droplet pattern represents the aqueous solution. The dashed line on the left represents the semipermeable membrane with sparse pores (i.e., the first semipermeable membrane 1), and the dashed lines on the right represents the semipermeable membrane with dense pores (i.e., the second semipermeable membrane 2). According to the new osmotic pressure formula, i.e., equation (8), the left semipermeable membrane has sparse pores, corresponding to a lower osmotic pressure, while the right semipermeable membrane has dense pores, corresponding to a higher osmotic pressure. The pure water from both the left and right sides will spontaneously permeate into the aqueous solution 3 in the middle, causing the pressure in the center to increase gradually. The pore distribution density of the first semipermeable membrane 1 is lower than that of the second semipermeable membrane 2, resulting in a lower osmotic pressure on the side corresponding to the first semipermeable membrane 1 and a higher osmotic pressure on the side corresponding to the second semipermeable membrane 2. The aqueous solution in the middle has a high concentration, and the pure water from both sides will spontaneously permeate into the aqueous solution 3, causing the pressure in the center to increase continuously. When the pressure in the center reaches the osmotic pressure corresponding to the left side (i.e., the osmotic pressure corresponding to the first semipermeable membrane 1), the pure water on the left will no longer permeate in. However, the pure water on the right has not yet reached the osmotic pressure and will continue to permeate in, causing the central pressure to continue rising and gradually exceed the osmotic pressure on the left side. This pressure difference will cause the aqueous solution to form reverse osmosis against the left semipermeable membrane (i.e., the first semipermeable membrane 1), pushing the pure water out and causing it to flow to the left. In this way, a phenomenon occurs where the pure water continuously and spontaneously permeates from the right side and the pure water continuously and spontaneously flows out from the left side. Macroscopically, this appears as unidirectional flow until eventually, both sides reach pressure equilibrium. At this point, the pure water on the right side stops permeating in, and the pure water on the left side stops flowing out, and the system reaches an equilibrium state. As long as the following conditions are met: the pressure exerted on the second semipermeable membrane 2 by the aqueous solution 3 is less than the osmotic pressure of the second semipermeable membrane 2, thereby forming the osmotic effect, and the osmotic effect will cause water from the liquid containing water 5 to flow through the second semipermeable membrane 2 into the central aqueous solution 3. The pressure exerted on the first semipermeable membrane 1 by the aqueous solution 3 is greater than the osmotic pressure of the first semipermeable membrane 1, forming reverse osmosis, and the reverse osmosis causes water from the aqueous solution 3 to flow through the first semipermeable membrane 1 into the pure water 4. In this way, a macroscopic water flow phenomenon is formed, where water continuously flows from the right side of the second semipermeable membrane 2 into the left side of the first semipermeable membrane 1.

Similarly, assuming that at this moment the pressure in the central region is H_{C}, the hydrostatic pressures of the pure water on the left and right sides are H_{L} and H_{R}, respectively, and the permeability coefficients of the semipermeable membranes on the left and right sides are K_{L} and K_{R}, respectively, with the corresponding osmotic pressures on the left and right sides being π_{L} and π_{R}.

At this point, based on the new osmotic pressure formula, it can be derived equation (9) expressed as follows:

$${H}_{L} - {H}_{R} = {K}_{R} cRT - {K}_{L} cRT = ( {K}_{R} - {K}_{L} ) cRT \qquad ( 9 )$$

The equation (9) indicates that different permeability coefficients K of the two semipermeable membranes can also cause different water level differences on the left and right sides. In particular, when the solution concentration c is sufficiently high and there is a significant difference between K_{R} and K_{L}, the osmotic pressure difference between the left and right sides will be noticeable. For example, when K_{R}=1 and K_{L}=0.1, and the concentration c is 10%, the osmotic pressure difference corresponds to that of a 9% concentration solution, and the water level difference can reach several hundred meters.

Theoretically, the solute in the device is locked by the two semipermeable membranes and does not leak out, the solution concentration remains unchanged, there is no energy loss, and no energy is consumed during operation. The spontaneous reverse osmosis by the “membrane pore difference method” does not require any external force fields such as electric or magnetic fields, is not limited by the type of solute, and can easily generate a significant osmotic pressure difference. Therefore, it can be a key area for development.

Given that the device achieves the effect of a one-way valve based on the principle of osmosis, it can be termed an “osmotic one-way valve” and can be applied in the following ways.

### Embodiment 1

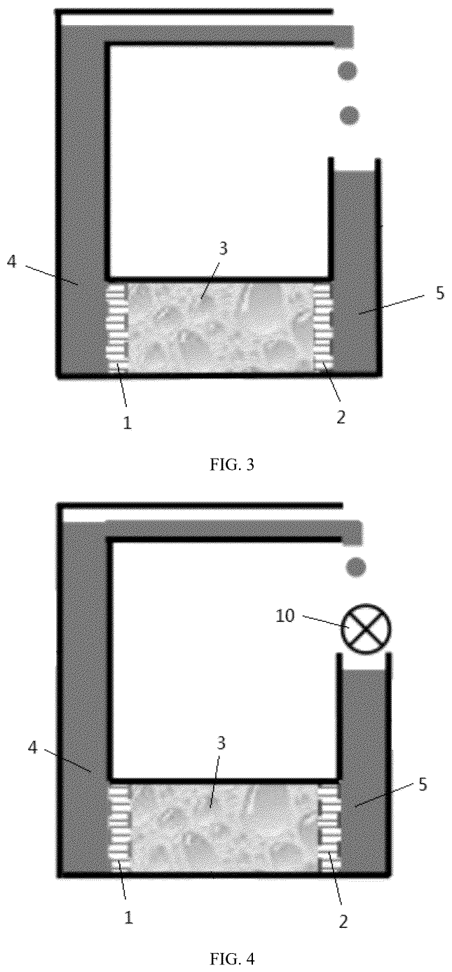

If water is allowed to flow from the left side to the right side and fall before the equilibrium water level is reached on the left side in FIG. 2 (for example, at half the height), as shown in FIG. 3, then the water on the right will continuously permeate through the solution and spontaneously flow to the left. The water level on the left will rise and then fall back to the right, forming a continuous water flow cycle. As long as the semipermeable membrane completely locks the solute and the concentration in the central chamber remains unchanged, this water flow cycle will never stop. If a turbine generator 10 is disposed to the lower end of the falling water on the right side as shown in FIG. 3, and electricity is generated using the water flow, energy can be continuously outputted. This achieves the goal of generating electricity by aggregating energy from the environment using the osmotic effect, as shown in FIG. 4.

Specifically, the pure water 4 flows into the second aqueous solution 5, and a generator 10 is installed between the pure water 4 and the second aqueous solution 5 to generate electricity using the water flow.

Additionally, it should be noted that as long as a water flow is generated, it can be used for power generation. Besides the vertical water flow mentioned above, other methods to create a water flow include draining water from the pure water 4 or allowing water from the pure water 4 to flow into the second aqueous solution 5, thereby creating a horizontal water flow. By installing a generator 10 at the location of the water flow, electricity can be generated.

At first glance, it may seem that spontaneous reverse osmosis cycle power generation violates the law of conservation of energy, but this is not the case. Osmosis relies on molecular thermal motion. The process described above is essentially the spontaneous conversion of the chaotic thermal motion of water molecules into macroscopic water flow for power generation, facilitated by the one-way valve effect. The thermal energy of the water inside the device is partially converted into electrical energy and transmitted outward, causing the water temperature to decrease. Since the surrounding environment is at a higher temperature, heat will spontaneously flow from the high-temperature area to the low-temperature area, replenishing the environmental thermal energy of the water and maintaining the ability to do work and continuously output energy. The entire process conserves energy. Therefore, this type of power generation essentially converts environmental thermal energy into electrical energy. After the electrical energy is consumed, it turns back into heat and returns to the environment, where it diffuses and replenishes the thermal energy at the power generation site, continuing to support the system's operation and forming a cycle.

Air has a low heat capacity and poor thermal conductivity, while water has a high heat capacity and good thermal conductivity. In practical applications, the power generation device mentioned above can be sealed and operated underwater to enhance its ability to absorb heat from the environment and improve power generation efficiency.

Currently, there are existing technologies that utilize the principle of osmosis for power generation, such as river-sea salinity gradient osmotic power generation. Norway has taken the lead in developing the world's first river-sea osmotic power generator. At first glance, spontaneous reverse osmosis cycle power generation appears very similar to river-sea osmotic power generation, but they are fundamentally different in nature and have significantly different potential applications. The concentration of seawater is approximately 3.5%, and the osmotic pressure difference in a typical osmotic power generator corresponds to a water head difference of about 240 meters. Spontaneous reverse osmosis can achieve a much higher water head difference. For example, using the formula H_{L}−H_{R}=K_{R}cRT−K_{L}cRT=(K_{R}−K_{L})cRT, where K_{R}=1, K_{L}=0.1, and c is a 10% concentration salt solution, the osmotic pressure difference is equivalent to that of 9% concentration seawater, which corresponds to a water head difference of about 620 meters. Seawater salt ions are very small, so river-sea osmotic power generation can only use semipermeable membranes with small pore sizes, resulting in low water flow rates. In contrast, spontaneous reverse osmosis cycle power generation can use larger solute particles with larger pore size semipermeable membranes, significantly increasing the water flow rate. Therefore, theoretically, spontaneous reverse osmosis cycle power generation can achieve higher water head differences and greater water flow rates compared to river-sea osmotic power generation, leading to significantly higher power generation efficiency. Pure solutions can completely avoid semipermeable membrane clogging, overcoming the biggest challenge for practical application of river-sea osmotic power generation. It is expected that spontaneous reverse osmosis cycle power generation will have greater potential and advantages in terms of power generation efficiency, applicability, durability, and cost-effectiveness compared to river-sea osmotic power generation.

### Embodiment 2

If the first aqueous solution 3, the pure water 4, and the second aqueous solution 5 as shown in FIG. 2 do not reach the equilibrium water level, the pure water 4 on the left side can flow to an upper end, which can create the water-lifting form shown in FIG. 5, thereby lifting water from a lower position to a higher position. This is the basic principle of the power-free water-lifting technology. Theoretically, the water-lifting height can reach several hundred meters, which can be used not only to meet the daily production and living needs but also for energy storage and power generation.

Specifically, as shown in FIG. 5, when the device is used to lift water from the lower position to the higher position, the second aqueous solution 5, the second semipermeable membrane 2, the first aqueous solution 3, the first semipermeable membrane 1, and the pure water 4 are set sequentially from bottom to top. The second aqueous solution 5 is pure water. The pure water 5 flows from the lower position through the second semipermeable membrane 2 into the first aqueous solution 3, and then water from the first aqueous solution 3 flows through the first semipermeable membrane 1 into the pure water 4 at the higher position.

In addition, the pure water 4 can also be directly drained and transported to the user end, without the need for the above vertical arrangement.

### Embodiment 3

The device of the disclosure can be used for desalination of seawater or purification of wastewater. In this case, the second aqueous solution 5 is seawater or wastewater. When the solution on the right side is seawater or wastewater, its concentration is c_{R}. According to the new osmotic pressure formula, equation (10) can be derived and expressed as follows:

$${H}_{L} - {H}_{R} = {K}_{R} ( c - {c}_{R} ) R T - {K}_{L} cRT = ( {K}_{R} - {K}_{L} ) cRT - {K}_{R} {c}_{R} R T \qquad ( 10 )$$

where a first term on the right side of the equation (10), (K_{R}−K_{L}) CRT represents the osmotic pressure difference formed by the different semipermeable membranes on the left and right sides. The second term, K_{R}c_{R}RT represents the osmotic pressure corresponding to the concentration of seawater or wastewater. As long as the first term is greater than the second term, that is, (K_{R}−K_{L})cRT>K_{R}c_{R}RT, water molecules from the seawater or wastewater in the right chamber can permeate into the central chamber and then undergo reverse osmosis to the left chamber, achieving energy-free desalination of seawater and purification of wastewater.

For example, if K_{R}=1, K_{L}=0.1, and the central chamber contains a 10% saltwater solution (c=10%), then the osmotic pressure difference corresponding to the first term (K_{R}−K_{L})cRT is equivalent to the osmotic pressure of a 9% saltwater solution, which corresponds to a water head difference of approximately 620 meters. If the right chamber contains seawater with a concentration of 3.5%, then the second term K_{R}c_{R}RT corresponds to a water head difference of approximately 240 meters. Subtracting the second term from the first term yields a reverse osmotic pressure equivalent to the osmotic pressure of a 5.5% saltwater solution, which corresponds to a water head difference of about 380 meters. This is equivalent to applying 38 atmospheres of pressure in a typical reverse osmosis seawater desalination device, which is a significant improvement. The entire process does not require the input of energy for pressurization and occurs spontaneously.

The above analysis also applies to sewage purification.

Based on the nanoscale one-way valve interpretation model, the disclosure elucidates the microscopic working mechanism of the osmotic effect and derives the osmotic pressure formula. According to the new interpretation and the osmotic pressure formula, an energy-free and spontaneous reverse osmosis device is proposed using the “membrane pore difference method” to create a one-way valve effect. This allows water to flow spontaneously from a lower position to a higher position, achieving the goal of directly utilizing the environmental thermal energy of water to do work.

The related principles and methods are conducive to achieving the following fundamental breakthroughs, which are of great theoretical significance.
A. Spontaneous reverse osmosis.
B. Allowing water to spontaneously flow from a lower position to a higher position.
C. No temperature difference is required; directly utilizing the environmental thermal energy of water to do work.

The above-mentioned breakthroughs have been tested and confirmed through experiments using the concentration difference method and the membrane pore difference method. These theoretical breakthroughs facilitate the emergence of new technologies. The core technology formed by the disclosure can be termed differently based on various perspectives as follows. From the perspective of the energy source, it is called molecular energy technology. From the distinction compared to traditional thermodynamic work based on temperature differences, it can be termed temperature-difference-free thermodynamic work technology. From the principle and function, it can be called osmotic one-way valve technology. From the phenomenon and energy-saving perspective, it can be referred to as energy-free reverse osmosis technology. From the application standpoint, it is expected to promote the development of new technologies and have a significant impact on related industries and fields.

Energy is the foundation for human survival and development, while energy consumption exacerbates the increase in global temperatures, posing a severe challenge. This disclosure helps to promote a new understanding of environmental thermal energy, moving away from the simplistic view that environmental thermal energy is waste heat, and potentially turning it into a valuable resource. Directly utilizing environmental thermal energy to do work not only holds the promise of addressing the issue of human energy sources but also aims to eliminate the root cause of increased global warming due to energy consumption. This is precisely the kind of clean energy that humanity has been eagerly awaiting, and it is hoped that it will receive attention and development to initiate the application of molecular energy as soon as possible.

Apparently, those skilled in the art can make various modifications and variations to the disclosure without departing from the spirit and scope of the disclosure. Thus, any modifications and variations of the disclosure, if falling within the scope of the claims of the disclosure and their equivalents, are also intended to be included.

What is claimed is:

1. An energy-free and spontaneous reverse osmosis device, comprising: a first semipermeable membrane (1) and a second semipermeable membrane (2);
wherein a pore distribution density of the first semipermeable membrane (1) is lower than that of the second semipermeable membrane (2), and a first aqueous solution (3) is filled between a side of the first semipermeable membrane (1) and a side of the second semipermeable membrane (2), another side of the first semipermeable membrane (1) is filled with pure water (4), and another side of the second semipermeable membrane (2) is filled with a second aqueous solution (5); and
wherein a first pressure exerted on the second semipermeable membrane (2) by the first aqueous solution (3) is less than an osmotic pressure of the second semipermeable membrane (2), thereby creating an osmotic effect to cause water from the second aqueous solution (5) to flow through the second semipermeable membrane (2) into the first aqueous solution (3); a second pressure exerted on the first semipermeable membrane (1) by the first aqueous solution (3) is greater than an osmotic pressure of the first semipermeable membrane (1), thereby creating reverse osmosis to cause water from the first aqueous solution (3) to flow through the first semipermeable membrane (1) into the pure water (4).

2. The energy-free and spontaneous reverse osmosis device as claimed in claim 1, wherein a particle size of a solute in the first aqueous solution (3) is larger than a pore size of the first semipermeable membrane (1) and a pore size of the second semipermeable membrane (2).

3. The energy-free and spontaneous reverse osmosis device as claimed in claim 1, wherein a relationship between the first semipermeable membrane (1) and the osmotic pressure or a relationship between the second semipermeable membrane (2) and the osmotic pressure is expressed as follows:
$$π = KcRT$$
where π represents the osmotic pressure, c represents a concentration difference between two sides of the first semipermeable membrane (1) or two sides of the second semipermeable membrane (2), K represents a permeability coefficient of the first semipermeable membrane (1) or the second semipermeable membrane (2), R represents a universal gas constant, and T represents a thermodynamic temperature.

4. The energy-free and spontaneous reverse osmosis device as claimed in claim 1, wherein the second aqueous solution (5) is pure water, seawater or sewage.

5. The energy-free and spontaneous reverse osmosis device as claimed in claim 4, wherein when the second aqueous solution (5) is the pure water, the device is configured to lift the pure water from a lower position to a higher position, or to perform water supply, or to perform power generation.

6. The energy-free and spontaneous reverse osmosis device as claimed in claim 5, wherein when the device is configured to lift the pure water from the lower position to the higher position sequentially from the second aqueous solution (5), the second semipermeable membrane (2), the first aqueous solution (3), the first semipermeable membrane (1), and the pure water (4); and
wherein water of the second aqueous solution (5) flows from the lower position through the second semipermeable membrane (2) into the first aqueous solution (3), and the water in the aqueous solution (3) flows through the first semipermeable membrane (1) into the pure water (4) at the higher position.

7. The energy-free and spontaneous reverse osmosis device as claimed in claim 5, wherein when the device is configured to perform the water supply, the pure water (4) is delivered to a user end.

8. The energy-free and spontaneous reverse osmosis device as claimed in claim 5, wherein when the device is configured to perform the power generation, the pure water (4) is drained or allowed to flow into the second aqueous solution (5), thereby creating a water flow; a generator (10) is disposed in a path of the water flow to generate electricity using the water flow.

9. The energy-free and spontaneous reverse osmosis device as claimed in claim 4, wherein when the second aqueous solution (5) is the seawater or the sewage, the device is configured to perform seawater desalination or sewage purification.
